(19) United States
(12) Patent Application Publication
(10) Pub. No.: US 2004/0213543 A1
(43) Pub. Date: Oct. 28, 2004

(54) Digital multifunctional equipment with improved image displaying function

(76) Inventor: Takehiro Onomatsu, Osaka (JP)

Correspondence Address: Jonathan P. Osha, OSHA & MAY L.L.P., Suite 2800, 1221 McKinney Street, Houston, TX, 77010, US

(21) Appl. No.: 10/829,649

(22) Filed: Apr. 22, 2004

(30) Foreign Application Priority Data
Apr. 25, 2003 (JP) 2003-122375(P)

(51) Int. Cl. H04N 5/76; H04N 5/781

(52) U.S. Cl. 386/46; 386/125

(57) ABSTRACT

In a digital broadcasting receiving apparatus accommodating a DVD playback apparatus, an HD apparatus, and a tuner apparatus for receiving digital broadcasting signals, a decoder forms an image based on digital information supplied from any of these apparatuses. The formed image is output to a monitor apparatus connected externally, with an image showing related information interposed thereon. The image of related information is output in a manner allowing the interposing image based on digital information to be visually recognized, by the adjustment of parameters of the graphic data.

### BACKGROUND OF THE INVENTION

1. Field of the Invention

The present invention relates to digital multifunctional equipment with improved image displaying function, and specifically, to digital multifunctional equipment capable of displaying information related to an image that has been displayed on a screen to be superimposed thereon.

2. Description of the Background Art

Japanese Utility Model Laying-Open No. 63-106279 provides an apparatus for displaying text expressing desired information to be superimposed on an image on a screen.

Further, Japanese Patent Laying-Open No. 11-338459 provides an apparatus for displaying a handwritten input line image to be superimposed on a still image having been displayed on a display such as of liquid crystal display elements, while moving the line image to any position or scaling up/down the line image.

Still further, there is also provided a still image function enabling a user to cause the received frame of digital broadcastings to pause at any timing. In the still image displaying state, information for notifying the user of the still state may be displayed by an OSD (On Screen Display) overlapped (superimposed) on the still image, or the frame is caused to pause without displaying any information.

Displaying information by the OSD means that additional information is displayed by the OSD on the still image. Therefore, for example when a telephone number that is desired by the user to see is contained in the still image, the telephone number will be covered by the information presented by the OSD and becomes difficult to be seen. There has been a growing trend in recent years that the types of information to be displayed by the OSD along with a still image (e.g., when it is the still image taken by a digital camera, information such as the date of shooting, numbers of pictures and the like) increase, as the types of still image recording function increase.

Further, when only the still image is displayed and no additional information is presented by the OSD, even when the still image is displayed in the state not intended by a user, the user cannot be notified that the still image is displayed.

Still further, it is also possible to split a screen into an area for displaying a still image and an area for displaying information by the OSD, rather than displaying the information by the OSD to be superimposed on the still image, and thus to use, for example, the edge portions of the screen (top, bottom, right and left portions) specially as the area for displaying the information by the OSD. In this case, as the still image is cut off or changed in size, the still image itself becomes difficult to be seen.

As described above, conventionally, there has been a problem that though an original image can be displayed on a screen while simultaneously displaying information related to the image by the OSD or the like, indication of the information makes the original image difficult to be seen.

### SUMMARY OF THE INVENTION

An object of the present invention is to provide digital multifunctional equipment that can solve difficulty in seeing images, when simultaneously displaying an image based on digital information and additional information other than the image on the same screen.

In order to achieve the object above, digital multifunctional equipment having a plurality of pieces of equipment for supplying different types of digital information according to one aspect of the present invention includes: an image forming portion for forming an image based on digital information supplied from any of the plurality of pieces of equipment; an output portion for outputting the image based on the digital information formed by the image forming portion to a pre-prepared monitor; and an image superimposition output portion for outputting an image of prescribed information to be superimposed on the image based on the digital information output from the output portion to the monitor. The image superimposition output portion outputs the image of prescribed information in a manner that allows the image based on the digital information to be visually recognized on the monitor.

Accordingly, when an image of prescribed information is output on a monitor along with an image based on digital information, the image of prescribed information is displayed to be superimposed on the image based on digital information in a manner allowing the image based on digital information to be visually recognized.

Therefore, even when an image based on digital information and another image of prescribed information are simultaneously displayed on the same screen, the image based on digital information will not become difficult to be seen.

Preferably, the image superimposition output portion generates graphic data for the image of prescribed information, and changes at least one parameter determining an output manner of the graphic data. Thus, the image of prescribed information is displayed in a manner allowing the image based on digital information to be visually recognized, by changing the parameters of the graphic data.

Preferably, the plurality of pieces of equipment includes a tuner for a digital broadcasting signal for the digital information. Thus, even when additional image of prescribed information is displayed on a monitor to be superimposed on an image based on digital broadcasting signal, the visibility of the image based on digital broadcasting signal will not be impaired.

Preferably, the digital multifunctional equipment is a digital broadcasting receiving apparatus. Thus, in a digital broadcasting receiving apparatus having a plurality of pieces of equipment for supplying different types of digital information, an image of prescribed information can be displayed to be superimposed on an image based on digital information supplied from any pieces of the equipment, without impairing the visibility thereof.

Preferably, the prescribed information is information related to an image based on digital information.

The plurality of pieces of equipment may include equipment playing back digital information from a magnetic disk, for example, HD (Hard disk) apparatus. Further, they may include equipment playing back digital information from an optical disc, for example, DVD (Digital Versatile Disc) apparatus. Still further, they may include equipment accepting digital information that is provided from an external apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a digital broadcasting receiving apparatus according to a present embodiment.

FIG. 2 is a flowchart showing a procedure of information display by an OSD in parallel with image display according to the present embodiment.

FIG. 3 is a diagram showing exemplary display when the procedure of FIG. 2 is followed.

### DESCRIPTION OF THE PREFERRED EMBODIMENTS

In the following, an embodiment of the present invention will be described in detail referring to the drawings.

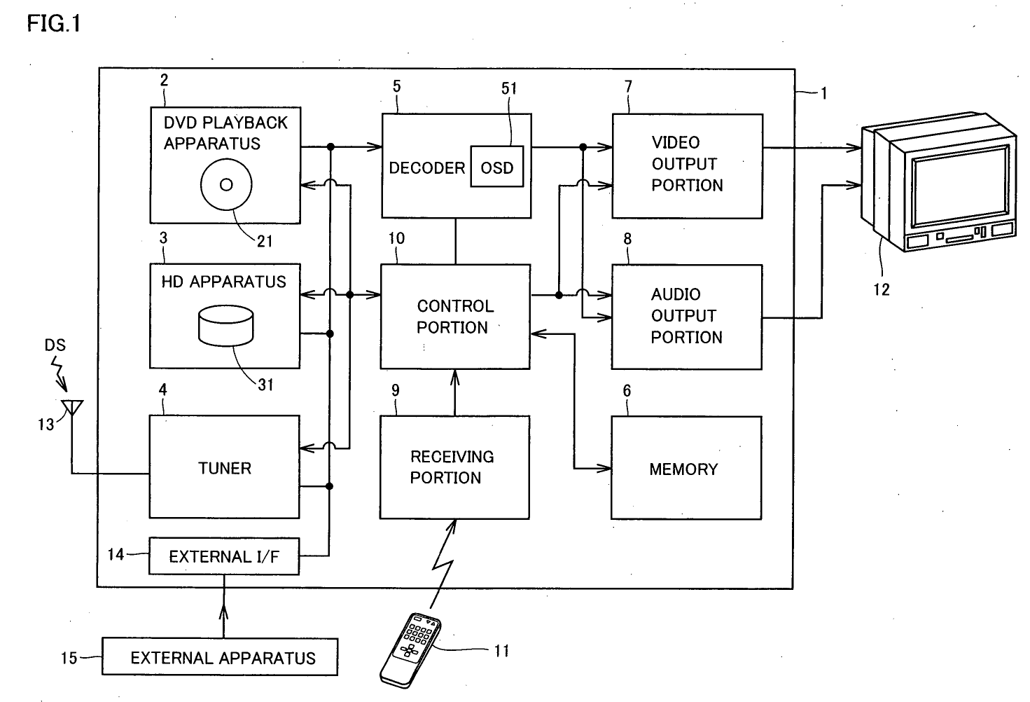

Referring to FIG. 1, a digital broadcasting receiving apparatus 1 accommodates a DVD playback apparatus 2 playing back and outputting information recorded on DVD 21, and hard disk 31 that is a magnetic disk, and includes HD apparatus 3 recording digital information in the hard disk 31 and playing back digital information contents from hard disk 31, a tuner 4 connecting an external antenna 13 for receiving digital broadcasting signal DS transmitted from a broadcasting station (not shown), a decoder 5 accommodating OSD 51, memory 6, a video output portion 7, an audio output portion 8, a receiving portion 9 receiving an instruction signal from a remote controller 11 a control portion 10 formed with a microcomputer and controlling and monitoring other components, and an external I/F (interface) 14 connecting an external apparatus 15 for externally supplying digital information to digital broadcasting receiving apparatus 1. I/F 14 is equipment for inputting digital information supplied from external apparatus 15. Digital broadcasting receiving apparatus 1 connects a monitor apparatus 12 for outputting images and audios. Digital broadcasting receiving apparatus 1 in FIG. 1 is provided as digital multifunctional equipment accommodating equipment for supplying digital information, such as tuner 4, DVD playback apparatus 2, HD apparatus 3, and external I/F 14.

DVD playback apparatus 2 is an apparatus for reading and playing back signals of digital contents recorded on DVD 21 of an optical disc. HD apparatus 3 is an apparatus for recording the signals of digital contents desired by a user in hard disk 31, and reading the signals of digital contents that has been recorded in advance from hard disk 31. Here, some of the signals to be recorded in hard disk 31 are, for example, signals for video files compliant with MPEG2 (Motion Picture Experts Group 2) standard and audio files compliant with MP3 (MPEG-1 Audio Layer 3) standard.

When digital broadcasting signal DS transmitted from a broadcasting station is input to tuner 4 through antenna 13, tuner 4 extracts and outputs broadcasting signal of a channel specified by control portion 10 (a signal of digital contents) from input digital broadcasting signal DS.

When any signal among a signal of digital contents played back by DVD playback apparatus 2, a signal of digital contents read by HD apparatus 3 from hard disk 31, a signal of digital contents output from tuner 4, and a signal of digital contents input by external apparatus 15 via external I/F 14 is provided to decoder 5, being switched by control of control portion 10, decoder 5 receives the provided signal of digital contents and decodes it to generate and output image data to be displayed on monitor apparatus 12 and audio data to be output from monitor apparatus 12. OSD 51 accommodated in decoder 5 outputs graphic data provided by control portion 10 to video output portion 7 to be visually displayed on the screen of monitor apparatus 12.

In memory 6, channel numbers identifying one or more broadcasting channels that can be received by tuner 4 are obtained by channel scanning (auto scanning) in advance and stored. Memory 6 also stores various programs executed by the microcomputer of control portion 10. Audio output portion 8 receives audio data output from decoder 5 and converts the input audio data into an audio signal that can be output from monitor 12, and outputs it to monitor apparatus 12. Receiving portion 9 receives an infrared signal transmitted from remote controller 11, and demodulates the received infrared signal. Then, receiving portion 9 outputs an instruction signal obtained by the demodulation to control portion 10. Control portion 10 controls components of the apparatus based on the programs stored in memory 6. Remote controller 11 is an apparatus operated by a user for inputting various instructions, and it transmits an infrared signal modulated in accordance with the input instructions.

The program of digital broadcasting signal DS received through antenna 13 can be recorded in hard disk 31 by HD apparatus 3, while being output as images to monitor apparatus 12 in real time through tuner 4 and decoder 5. During the recording, by the so-called chasing playback (time-shift playback) function, it is possible to start playback of the program from its beginning part recorded in hard disk 31, or by using double-speed audio playback function or the like, it is possible to playback the data of the program already recorded in hard disk 31 to catch up with the real time broadcastings.

Antenna 13 receives digital broadcasting signal DS, and tuner 4 extracts a signal of a desired channel from the received digital broadcasting signal DS and outputs it to decoder 5. Decoder 5 decodes digital broadcasting signal DS of the desired channel, and outputs the resulting data to video output portion 7 and audio output portion 8. Thus, an image is displayed on monitor apparatus 12 and an audio is output from monitor apparatus 12 through video output portion 7 and audio output portion 8, respectively. At this stage, in decoder 5, the image data generated based on the signal is displayed on monitor apparatus 12 through video output portion 7, while being buffered, i.e., being written to a buffer (not shown) inside decoder 5 and thereafter read out. When a user watching the screen of monitor apparatus 12 instruct to stop updating the displayed image by operating remote controller 11, control portion 10 controls decoder 5 such that the image being buffered and displayed on the screen at the moment of the input of the instruction becomes a still image on monitor apparatus 12 (such that it will not be updated). Thus, decoder 5 stops updating (overwriting) of the image data inside the buffer (not shown) such that only the same image data is repeatedly read, and outputs a signal notifying the control portion 10 that updating is stopped.

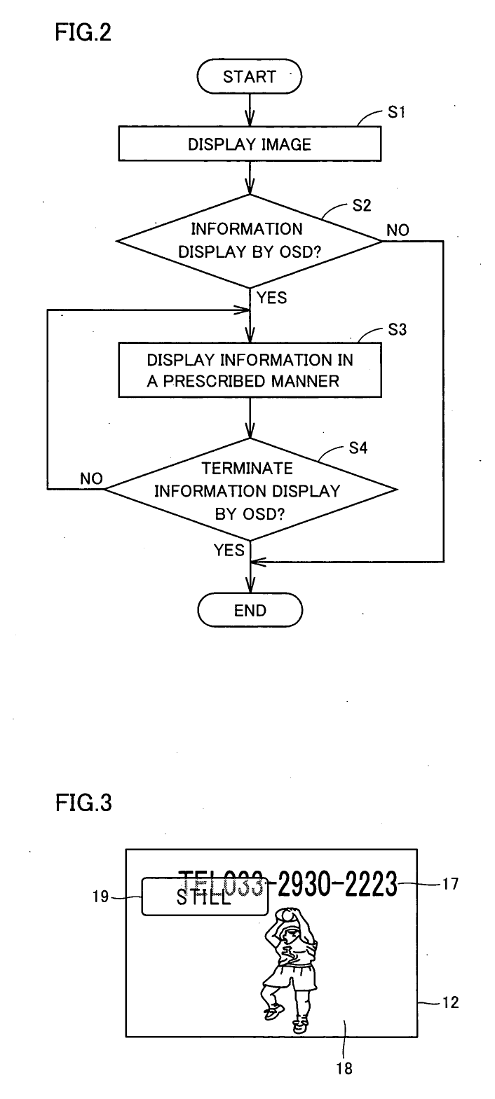

Referring to the flowchart of FIG. 2, the operation will be described where an image by real-time broadcasting of digital broadcasting signal DS is cause to pause on the screen of monitor apparatus 12, and simultaneously an image of graphic data of the information related to the image is displayed on the same screen using OSD 51. The program that follows the flowchart of FIG. 2 is stored in memory 6 in advance, and read and executed by the microcomputer of control portion 10.

First, when a user operates remote controller 11 and instructs to stop updating the displayed image on monitor apparatus 12, the instruction signal is provided to control portion 10 through receiving portion 9. Thus, control portion 10 controls decoder 5 based on the instruction signal such that it does not update the currently displayed image (to be still). Thus, the image is shown as still image 18 of FIG. 3, for example (Step (hereinafter simply referred to as S) 1). Assume that a user watching a broadcasting program gives an instruction for causing the image to pause at the timing when a telephone number that he/she desires to check is displayed on monitor apparatus 12, and still image 18 containing the image of telephone number 17 desired to be checked is displayed on monitor 12, for example as in FIG. 3.

When control portion 10 detects that image 18 is displayed based on the input of the signal notifying that updating of an image data inside buffer is stopped from decoder 5, then it determines that it must present information by graphic data with OSD 51, i.e., it must present information to notify the user that updating of the image is intentionally, not erroneously, stopped (YES at S2). Then, as it generates the graphic data and provides it to OSD 51, an image according to the graphic data is generated by OSD 51 and displayed on monitor apparatus 12 in a prescribed manner via video output portion 7 (S3).

Here, in order to notify the user that the still image is intentionally and not erroneously displayed, as shown in FIG. 3, text image 19 of “STILL” is displayed to be superimposed on still image 18 by OSD 51. As image 19 is displayed as superimposed on image 18, information of image 18 may be covered by image 19, or image of telephone number 17 desired by the user may be covered depending on the position of image 19.

Accordingly, in the present embodiment, the output manner of image 19 is modified such that image 18 is ensured to be visible even when image 19 is displayed as superimposed thereon. Specifically, control portion 10 modifies the output (displaying) manner of image 19 by adjusting one or more of parameters such as color opacity, displaying position, instruction to superimpose/not to superimpose on image 18 and the like for the graphic data of image 19 displayed as superimposed on image 18 by OSD 51. By adjusting the parameter of color opacity, the opacity of image 19 can be changed arbitrarily. Accordingly, when image 19 is superimposed on image 18, by adjusting the parameter of color opacity, the color of image 19 can be made deeper or lighter than that of image 18, and furthermore, image 19 can be made completely transparent to image 18. By adjusting the parameter of display position, image 19 can be moved. By adjusting the parameter of instruction to superimpose/not to superimpose, image 19 can be blinked. It should be noted that the types of parameters are not limited thereto.

Accordingly, while image 19 may be superimposed on image 18, by changing the parameters, image 19 can be displayed transparently, displayed blinking, or displayed continuously moving in the screen vertically and horizontally. Therefore, such a situation that image 18 containing telephone number image 17 is covered by image 19 and cannot be seen, or the display area of image 18 is limited by the display area of image 19 and causing image 18 difficult to be seen can be prevented.

Thereafter, control portion 10 determines whether to terminate information display by OSD 51 (S4). For example, it determines based on whether an input of user's instruction to cancel the still image display through remote controller 11 is present or not. When the instruction signal is input, control portion 10 controls OSD 51 to clear image 19 of FIG. 3, and sets decoder 5 to the original state for continuously displaying image of real-time broadcasting by digital broadcasting signal DS. In other words, OSD 51 stops to output data of image 19 to video output portion 7, while decoder 5 cancels overwriting prohibition of the buffer and returns to the original buffering state.

It should be noted that the information displayed by image 19 is not limited to those shown in FIG. 3. Further, while image 18 is described to be a still image, it may also be a moving image. For example, it may be the moving image of a program of digital broadcasting signal DS received at antenna 13 in real time. In this case, the number of the receiving channel or the information of the program title extracted from digital broadcasting signal DS may be displayed by image 19. Additionally, while image 18 obtained from the data of a recorded program through the so-called time-shift playback or double speed playback from hard disk 31 by HD apparatus 3 is displayed on monitor apparatus 12, text information image 19 of “time-shift playback” or “double speed playback” may be presented, in various displaying manners as described above. Additionally, a moving image or a still image based on data read from DVD 21 by DVD playback apparatus 2 may be displayed as image 18, in which case the title of the data may be read from DVD 21 and displayed by image 19.

Further, image 18 may be a moving image or a still image based on digital information supplied from external apparatus 15 through external I/F 14. When external apparatus 15 is, for example, a digital camera, image 18 based on the information of the taken image is displayed. In this case, the types of information presented by image 19 displayed by OSD 51 may include information such as the date of shooting, the number of pictures. It should be noted that external apparatus 15 is not limited to a digital camera.

Additionally, the apparatus provided to digital broadcasting receiving apparatus 1 for supplying data for image 19 to be displayed on monitor display 12 through decoder 5 is not limited to DVD playback apparatus 2, HD apparatus 3 or the like, and it may be an apparatus of other types.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Digital multifunctional equipment having a plurality of pieces of equipment for supplying different types of digital information, comprising:
image forming means for forming an image based on digital information supplied from any of said plurality of pieces of equipment;
output means for outputting said image based on the digital information formed by said image forming means to a pre-prepared monitor; and
image superimposition output means for outputting an image of prescribed information to be superimposed on said image based on the digital information output from said output means to said monitor; wherein
said image superimposition output means outputs said image of prescribed information in a manner that allows said image based on the digital information to be visually recognized on said monitor.

2. The digital multifunctional equipment according to claim 1, wherein said image superimposition output means generates graphic data for said image of prescribed information, and changes at least one parameter determining an output manner of said graphic data.

3. The digital multifunctional equipment according to claim 2, wherein said digital multifunctional equipment is a digital broadcasting receiving apparatus.

4. The digital multifunctional equipment according to claim 1, wherein said plurality of pieces of equipment includes a tuner for a digital broadcasting signal for said digital information.

5. The digital multifunctional equipment according to claim 4, wherein said digital multifunctional equipment is a digital broadcasting receiving apparatus.

6. The digital multifunctional equipment according to claim 1, wherein said digital multifunctional equipment is a digital broadcasting receiving apparatus.

7. The digital multifunctional equipment according to claim 1, wherein said prescribed information is information related to said image based on the digital information.

8. The digital multifunctional equipment according to claim 1, wherein said plurality of pieces of equipment include equipment playing back said digital information from a magnetic disk.

9. The digital multifunctional equipment according to claim 1, wherein said plurality of pieces of equipment include equipment playing back said digital information from an optical disc.

10. The digital multifunctional equipment according to claim 1, wherein said plurality of pieces of equipment include equipment accepting said digital information that is externally provided to said digital multifunctional equipment.
